(19) United States
(12) Patent Application Publication
(10) Pub. No.: US 2012/0282448 A1
(43) Pub. Date: Nov. 8, 2012

(54) METHODS FOR FABRICATING THREE-DIMENSIONAL OBJECTS

(75) Inventors: Michelle N. CHRETIEN, Mississauga (CA); Barkev KEOSHKERIAN, Thornhill (CA); Jennifer L. BELELIE, Oakville (CA); Naveen CHOPRA, Oakville (CA)

(73) Assignee: XEROX CORPORATION, Norwalk, CT (US)

(21) Appl. No.: 13/099,821

(22) Filed: May 3, 2011

(51) Int. Cl. B32B 5/00; B29C 35/08

(52) U.S. Cl. 428/220; 264/401

(57) ABSTRACT

A method for fabricating a three-dimensional object including depositing a composition containing a cationically curable compound, a cationic photoinitiator, a radically curable compound, a radical photoinitiator, and a gellant upon a surface to create a three-dimensional object; and curing the composition.

### TECHNICAL FIELD

The present disclosure generally relates to methods for three-dimensional printing using a curable composition.

### RELATED APPLICATIONS

U.S. patent application Ser. No. 12/204,307, which is hereby incorporated by reference herein in its entirety, describes, in embodiments, a method of fabricating a three-dimensional object comprising depositing a first amount of an ultraviolet curable phase change ink composition comprising an optional colorant and a phase change ink vehicle comprising a radiation curable monomer or prepolymer, a photoinitiator, a reactive wax, and a gellant upon a print region surface, successively depositing additional amounts of the ultraviolet curable phase change ink composition to create a three-dimensional object, and curing the ultraviolet curable phase change ink composition.

U.S. patent application Ser. No. 12/204,269, which is hereby incorporated by reference herein in its entirety, describes, in embodiments, an ink jet printing device including an ink jet print head and a print region surface toward which ink is jetted from the ink jet print head, wherein a height distance between the ink jet print head and the print region surface is adjustable; wherein the ink jet print head jets an ultra-violet curable phase change ink composition comprising an optional colorant and a phase change ink vehicle comprising a radiation curable monomer or prepolymer; a photoinitiator; a reactive wax; and a gellant, wherein a print deposited upon the print region surface is Braille, raised print, or a combination of regular print and one or both Braille and raised print.

U.S. patent application Ser. No. 12/204,323, which is hereby incorporated by reference herein in its entirety, describes, in embodiments, a system and method for creating an authentication mark on a recording medium by depositing marking material on a medium in an image area to create a marking material image and to create a marking material authentication image. The marking material comprises an ultraviolet curable phase change ink composition comprising an optional colorant and a phase change ink vehicle comprising a radiation curable monomer or prepolymer; a photoinitiator; a reactive wax; and a gellant. A predetermined amount of additional marking material is further deposited upon the medium in the authentication image area to increase an amount of marking material associated with the marking material authentication image in the authentication image area. The fixed marking material associated with the authentication image area is a tactilely perceptible authentication mark having a height, with respect to a surface of the medium, that is tactilely perceptible, wherein the fixed marking material associated with the marking material image area is tactilely non-perceptible.

U.S. patent application Ser. No. 12/204,462, which is hereby incorporated by reference herein in its entirety, describes, in embodiments, a machine readable code comprising a set of printed markings created with an ultra-violet curable phase change ink comprising an optional colorant and a phase change ink vehicle comprising a radiation curable monomer or prepolymer; a photoinitiator; a reactive wax; and a gellant; wherein each printed marking of the set has a predetermined print height on a substrate and represents a predetermined data value, wherein the set of printed markings includes printed markings representing different data value and having different print heights.

U.S. patent application Ser. No. 12/765,309, which is hereby incorporated by reference herein in its entirety, describes, in embodiments, a composition for three-dimensional printing comprising a radiation curable monomer, a photoinitiator, a wax, and a gallant, wherein the cured composition has a room temperature modulus of from about 0.01 to about 5 GPa.

U.S. patent application Ser. No. 11/290,121, which is hereby incorporated by reference herein in its entirety, describes, in embodiments, a phase charge ink comprising a colorant, an initiator, and a phase change ink carrier, said carrier comprising at least one radically curable monomer compound and a compound of the formula

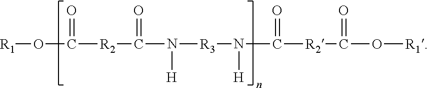

U.S. patent application Ser. No. 11/290,202, which is hereby incorporated by reference herein in its entirety, describes, in embodiments, a phase change ink comprising a colorant, an initiator, and an ink vehicle, said ink vehicle comprising a composition comprising (a) at least one radically curable monomer compound, and (b) a compound of the formula

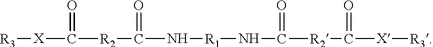

U.S. patent application Ser. No. 11/034,856, which is hereby incorporated by reference herein in its entirety, describes, in embodiments, an ink comprising an ink vehicle, wherein the ink vehicle comprises at least one curable component, and at least two photoinitiator systems, wherein the at least one curable component comprises a first component curable by a first polymerization route and a second component curable by a second polymerization route, wherein the second polymerization route is different from the first polymerization route and the at least two photoinitiator systems include a first photoinitiator system for the first component and a second photoinitiator system for the second component.

U.S. patent application Ser. No. 11/034,714, which is hereby incorporated by reference herein in its entirety, describes, in embodiments, an ink jet ink comprising an ink vehicle, wherein the ink vehicle comprises at least one wax monomer functionalized to include in the chain at least one reactive group curable upon exposure to radiation.

U.S. patent application Ser. No. 12/765,148, which is hereby incorporated by reference herein in its entirety, describes, in embodiments, amide gellant compounds with aromatic end groups.

### BACKGROUND

Described herein are methods for forming three-dimensional images and objects, such as by three-dimensional printing and digital fabrication, with a hybrid curable composition, such as an ink composition including hybrid radical and cationically curable monomers. The compositions, which include, for example, inks, of the present disclosure are important in manufacturing and curing digitally fabricated structures having complex geometries where not all surfaces will receive equal illumination, which is not currently possible by conventional analog or digital manufacturing methods.

Analog manufacturing is moving towards, and is expected to one day be consumed by, digital manufacturing. This shift is customer driven and arises from a desire for more customized products, on-demand delivery, and other market factors that support the move towards a less expensive alternative to traditional manufacturing.

Digital fabrication encompasses a wide range of technologies. Current technologies for three-dimensional printing include stereolithography and rapid prototyping. While suitable for some purposes, these technologies each have their own limitations. Stereolithography is a costly process with machines often costing in excess of $250,000. The polymer materials employed are also extremely expensive, with a common stereolithography photopolymer costing about $800 per gallon. Rapid prototyping systems typically use a fused deposition method wherein molten acrylonitrile-butadiene-styrene (ABS) polymer is deposited. The extremely rapid solidification of the ABS manifests in ridges that form on the finished object. Post-printing treatment of the prototype (such as sanding or polishing) is required to render a smooth object.

The concept of “freezing” or phase-change has been described for three-dimensional printing using aqueous inks on a chilled (that is, sub-zero temperature) substrate. See D. Mager et al., “Phase Change Rapid Prototyping With Aqueous Inks,” NIP23 and Digital Fabrication 2007 Conference Proceedings, pages 908-911, which is hereby incorporated by reference herein. Ink jet fabrication using wax based materials has been described but is disadvantaged by the fact that the resulting primary structures are neither robust nor permanent.

Further, B. A. Ficek et al. “Cationic photopolymerizations of thick polymer systems: Active center lifetime and mobility,” Eur. Polymer J. 2008, vo. 44, pp 98-105 describes a cationic photopolymerization. Cationic photopolymerization is essentially non-terminating and the long-lived active centers may lead to “dark cure” long after the illumination has ceased. Long-lived cationic active centers that are known to be responsible for dark cure can also lead to “shadow cure” of un-illuminated regions of thick systems. “Shadow cure” occurs when the active centers migrate out of the illuminated region, leading to polymerization of unexposed monomer.

U.S. patent application Ser. No. 11/613,759, which is hereby incorporated by reference herein in its entirety, describes, in embodiments, a system and method create an authentication mark on a recording medium by depositing marking material on a medium in an image area to create a marking material image and to create a marking material authentication image. A predetermined amount of additional marking material is further deposited upon the medium in the authentication image area to increase an amount of marking material associated with the marking material authentication image in the authentication image area. The fixed marking material associated with the authentication image area is a tactilely perceptible authentication mark wherein the fixed marking material associated with the authentication mark has a height, with respect to a surface of the medium, that is tactilely perceptible.

U.S. Pat. No. 6,644,763 describes a method for creating raised and special printing effects using ink jet technology. The method includes the steps of depositing a light curable photo-polymer material on the area selected for the printing effects, and curing the area. The amount of material to be deposited corresponds to the area selected for the printing effects and the height of the raised area relative to the medium on which the photo-polymer material is deposited.

Ink jet printing devices are known. For example, ink jet printing devices are generally of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium. There are generally three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (that is, liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

In a typical design of a piezoelectric ink jet device, the image is applied by jetting appropriately colored inks during four to eighteen rotations (incremental movements) of a substrate, such as an image receiving member or intermediate transfer member, with respect to the ink jetting head. That is, there is a small translation of the print head with respect to the substrate in between each rotation. This approach simplifies the print head design, and the small movements ensure good droplet registration. At the jet operating temperature, droplets of liquid ink are ejected from the printing device. When the ink droplets contact the surface of the recording substrate, they quickly solidify to form a predetermined pattern of solidified ink drops.

Ink jet printing processes may employ inks that are solid at room temperature and liquid at elevated temperatures. Such inks may be referred to as solid inks, hot melt inks, phase change inks and the like. For example, U.S. Pat. No. 4,490,731, the disclosure of which is totally incorporated herein by reference, discloses an apparatus for dispensing solid ink for printing on a substrate such as paper. In thermal ink jet printing processes employing hot melt inks, the solid ink is melted by the heater in the printing apparatus and utilized (jetted) as a liquid in a manner similar to that of conventional thermal ink jet printing. Upon contact with the printing substrate, the molten ink solidifies rapidly, enabling the colorant to substantially remain on the surface of the substrate instead of being carried into the substrate (for example, paper) by capillary action, thereby enabling higher print density than is generally obtained with liquid inks. Advantages of a phase change ink in ink jet printing are thus elimination of potential spillage of the ink during handling, a wide range of print density and quality, minimal paper cockle or distortion, and enablement of indefinite periods of nonprinting without the danger of nozzle clogging, even without capping the nozzles.

The use of ink jet printers in forming raised printed images is also known, for example, as indicated in U.S. Pat. Nos. 6,644,763 and 5,627,578 above.

U.S. patent application Ser. No. 11/683,011, which is hereby incorporated by reference hereinabove in its entirety, describes a cost-effective ink jet printing device that is capable of forming both regular print images and raised print images.

In general, phase change inks (sometimes referred to as “hot melt inks”) are in the solid phase at ambient temperature, but exist in the liquid phase at the elevated operating temperature of an ink jet printing device. At the jet operating temperature, droplets of liquid ink are ejected from the printing device and, when the ink droplets contact the surface of the recording substrate, either directly or via an intermediate heated transfer belt or drum, they quickly solidify to form a predetermined pattern of solidified ink drops. Phase change inks have also been used in other printing technologies, such as gravure printing, as disclosed in, for example, U.S. Pat. No. 5,496,879 and German Patent Publications DE 4205636AL and DE 4205713AL, the disclosures of each of which are totally incorporated herein by reference.

Phase change inks for color printing typically comprise a phase change ink carrier composition which is combined with a phase change ink compatible colorant. In a specific embodiment, a series of colored phase change inks can be formed by combining ink carrier compositions with compatible subtractive primary colorants. The subtractive primary colored phase change inks can comprise four component dyes or pigments, namely, cyan, magenta, yellow and black, although the inks are not limited to these four colors. These subtractive primary colored inks can be formed by using a single dye or pigment or a mixture of dyes or pigments. For example, magenta can be obtained by using a mixture of Solvent Red Dyes or a composite black can be obtained by mixing several dyes. U.S. Pat. Nos. 4,889,560; 4,889,761, and 5,372,852, the disclosures of each of which are totally incorporated herein by reference, teach that the subtractive primary colorants employed can comprise dyes from the classes of Color Index (C.I.) Solvent Dyes, Disperse Dyes, modified Acid and Direct Dyes, and Basic Dyes. The colorants can also include pigments, as disclosed in, for example, U.S. Pat. No. 5,221,335, the disclosure of which is totally incorporated herein by reference. U.S. Pat. No. 5,621,022, the disclosure of which is totally incorporated herein by reference, discloses the use of a specific class of polymeric dyes in phase change ink compositions.

Phase change inks have also been used for applications such as postal marking, industrial marking, and labeling.

Phase change inks are desirable for ink jet printers because they remain in a solid phase at room temperature during shipping, long term storage, and the like. In addition, the problems associated with nozzle clogging as a result of ink evaporation with liquid ink jet inks are largely eliminated, thereby improving the reliability of the ink jet printing. Further, in phase change ink jet printers wherein the ink droplets are applied directly onto the final recording substrate (for example, paper, transparency material, and the like), the droplets solidify immediately upon contact with the substrate, so that migration of ink along the printing medium is prevented and dot quality is improved.

Radiation curable inks generally comprise at least one curable monomer, a colorant, and a radiation activated initiator, for example a photoinitiator, that initiates polymerization of curable components of the ink, such as, for example, a curable monomer.

U.S. Pat. No. 7,279,587, the disclosure of which is totally incorporated herein by reference, discloses photoinitiating compounds useful in curable phase change ink compositions. In embodiments, a compound of the formula

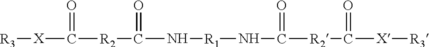

is disclosed wherein R1 is an alkylene, arylene, arylalkylene, or alkylarylene group, R2 and R₂′ each, independently of the other, are alkylene, arylene, arylalkylene, or alkylarylene groups, R₃ and R₃′ each, independently of the other, are either (a) photoinitiating groups, or (b) groups which are alkyl, aryl, arylalkyl, or alkylaryl groups, provided that at least one of R₃ and R₃′ is a photoinitiating group, and X and X′ each, independently of the other, is an oxygen atom or a group of the formula —NR₄—, wherein R₄ is a hydrogen atom, an alkyl group, an aryl group, an arylalkyl group, or an alkylaryl group.

U.S. patent application Ser. No. 11/290,202, which is hereby incorporated by reference herein in its entirety, describes, in embodiments, a phase change ink comprising a colorant, an initiator, and an ink vehicle, said ink vehicle comprising (a) at least one radically curable monomer compound, and (b) a compound of the formula

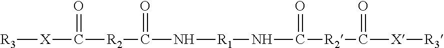

wherein R₁ is an alkylene, arylene, arylalkylene, or alkylarylene group, R₂ and R₂′ each, independently of the other, are alkylene, arylene, arylalkylene, or alkylarylene groups, R₃ and R₃′ each, independently of the other, are either (a) photoinitiating groups, or (b) groups which are alkyl, aryl, arylalkyl, or alkylaryl groups, provided that at least one of R₃ and R₃′ is a photoinitiating group, and X and X′ each, independently of the other, is an oxygen atom or a group of the formula —NR₄—, wherein R₄ is a hydrogen atom, an alkyl group, an aryl group, an arylalkyl group, or an alkylaryl group.

U.S. Pat. No. 7,279,587, which is hereby incorporated by reference herein in its entirety, describes, in embodiments, a process for preparing a compound of the formula

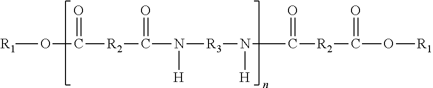

wherein R₁ is an alkyl group having at least one ethylenic unsaturation, an arylalkyl group having at least one ethylenic unsaturation, or an alkylaryl group having at least one ethylenic unsaturation, R₂ and R₃ each, independently of the others, are alkylene groups, arylene groups, arylalkylene groups, or alkylarylene groups, and n is an integer representing the number of repeat amide units and is at least 1, said process comprising:
(a) reacting a diacid of the formula

HOOC—R₂—COOH

with a diamine of the formula

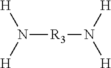

in the absence of a solvent while removing water from the reaction mixture to form an acid-terminated oligoamide intermediate; and (b) reacting the acid-terminated oligoamide intermediate with a monoalcohol of the formula

R₁—OH

in the presence of a coupling agent and a catalyst to form the product.

U.S. Pat. No. 7,276,614, which is hereby incorporated by reference herein in its entirety, describes, in embodiments, a compound of the formula

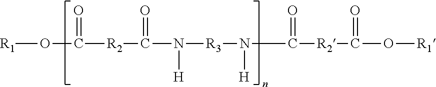

wherein R₁ and R₁′ each, independently of the other, is an alkyl group having at least one ethylenic unsaturation, an arylalkyl group having at least one ethylenic unsaturation, or an alkylaryl group having at least one ethylenic unsaturation, R₂, R₂′, and R₃ each, independently of the others, are alkylene groups, arylene groups, arylalkylene groups, or alkylarylene groups, and n is an integer representing the number of repeat amide units and is at least 1.

U.S. Pat. No. 7,271,284, which is hereby incorporated by reference herein in its entirety, describes, in embodiments, a process for preparing a compound of the formula

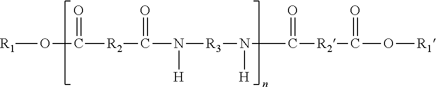

having substituents as defined therein.

The appropriate components and process aspects of the each of the foregoing U.S. Patents and Patent Publications may be selected for the present disclosure in embodiments thereof.

Given that digital fabrication or rapid prototyping using non-impact printing technology is beginning to impact a wide range of technical disciplines including biotechnology, combinatorial chemistry, electronics, displays, MEMS (micro electromechanical systems) devices, photovoltaics, and organic semiconductors a need remains for improved materials suitable for use in non-impact three dimensional printing including digital manufacturing. Further needed is a marking material for ink jet based three-dimensional printing and digital fabrication providing a final object having improved robustness, a method providing ease, simplicity of use, flexibility and tenability (that is, adaptability for different applications).

### SUMMARY

In embodiments, a method for fabricating a three-dimensional object comprises: depositing a composition comprising a canonically curable compound, a cationic photoinitiator, a radically curable compound, a radical photoinitiator, a gellant, optionally a curable wax, and optionally a colorant upon a surface to create a three-dimensional object; and curing the composition.

### DESCRIPTION OF THE EMBODIMENTS

The methods disclosed herein for fabricating a three-dimensional object may comprise: depositing a composition comprising a canonically curable compound, a cationic photoinitiator, a radically curable compound, a radical photoinitiator, a gellant, optionally a curable wax, and optionally a colorant upon a surface to create a three-dimensional object; and curing the composition. The composition may include both a cationic curable component and a radically curable component, and is referred to herein as a “hybrid” composition. By employing the methods of the present disclosure, the deposited and cured composition may achieve one or more of the following advantages: (1) lower cost, (2) smoother features, (3) tunable properties including phase transition temperature, gel strength, viscosity, modulus, and added functionality, and (4) improved curability as compared to radical-only curing formulations.

Due to the radiation curable nature of the canonically curable compound, the printed object can be photochemically cured by exposure to UV radiation following digital deposition at any point in the fabrication process. This allows a layer-by-layer construction of larger objects if necessary but more advantageously the phase change nature of the composition allows build-up of the three dimensional objects in multiple printing steps followed by fewer curing steps. The polymer material formed following curing gives robust objects with a high degree of mechanical strength.

By using the cationic photopolymerization, the cure can continue in the dark even after UV illumination has stopped. Moreover, the possibility of curing thick sections without the need for direct UV light exposure, such as by “shadow curing,” represents a significant advantage over a purely radical polymerization UV fabrication system that may require more energy and more frequent curing steps.

In embodiments, the cationically curable compound may comprise a cationically curable phase-change material for 3-dimensional printing, digital fabrication, and rapid prototyping (stereolithography) applications. Using the composition in non-impact printing enables the digital fabrication of structures with 3-dimensional and/or 2-dimensional sections at physical scales of nanometers to meters.

In embodiments, the hybrid compositions of the present disclosure are provided as materials for fabricating three-dimensional objects. Fabrication techniques may include, for example, inkjet-based digital fabrication. These hybrid compositions may be ink materials and may comprise a cationic curable compound or component and a radically curable compound or component, including, for example, radiation curable monomers, prepolymers, and/or oligomers, a photoinitiator package, an optional reactive wax, and a gellant. Pigments or other functional particles may be optionally included depending on the desired application.

In embodiments where the hybrid compositions of the present disclosures are prepared as ink materials, the rheological properties of the ink materials may be tuned to achieve robust jetting at elevated temperatures (for example, in embodiments, about 85° C.) and a degree of mechanical stability (for example, in embodiments, viscosities of from about 10⁵ to about 10⁶ centipoise) at ambient substrate temperatures (i.e. room temperature). The increase in viscosity to from about 10⁵ to about 10⁶ centipoise allows the structure to be constructed in the absence of curing. Before curing, however, the structures may have a consistency resembling tooth paste and can be altered by touch. By curing, the structures are rendered quite robust. The gel nature of the ink materials at room temperature prevents spread or migration of the printed droplet and allows for facile build-up of three-dimensional structures. Due to the curing characteristics of the hybrid compositions disclosed herein, the printed object can be cured at any point in the fabrication process resulting in robust objects with a high degree of mechanical strength, even at points in the fabrication process where not all surfaces will receive equal illumination. In specific embodiments, the ink materials disclosed herein may be cured after deposition of each layer of the three-dimensional object is deposited, if desired. Alternately, in embodiments, the ink materials may be cured upon completion of deposition of all layers of the three-dimensional object.

In embodiments, the methods disclose herein comprises depositing successive layers of one or more hybrid compositions, which may, for example, be a curable ink compositions (hereinafter “curable ink”), to form an object having a selected height and shape. For example, the successive layers of the curable ink may be deposited to a build platform or to a previous layer of solidified material in order to build up a three-dimensional object in a layerwise fashion. In embodiments, objects of virtually any design can be created, from a micro-sized scale to a macro-sized scale and can include simple objects to objects having complex geometries. The hybrid compositions, which may be ink jet materials, and method herein further advantageously provide a non-contact, additive process (as opposed to subtractive process such as computer numerical control machining) providing the built-in ability to deliver metered amounts of the present ink materials to a precise location in time and space.

Cationically Curable Compound

In embodiments, the composition comprises a cationically curable compound, that is, a compound including at least one cationically polymerizable moiety in which the cationic moieties are, for example, epoxide, vinyl ether or styrenic group. The term “curable compound” also includes curable oligomers, which may also be used in the compositions.

Suitable cationically curable compounds include, for example, cationically curable (polymerizable) monomers or oligomers. In embodiments, the cationically curable compound may comprise at least one moiety selected from the group consisting of an epoxide, a vinyl ether, and a styrenic group. Exemplary vinyl ethers may include those possessing low volatility, high reactivity and good health and safety properties. The cationically curable monomers may also be mono-, di- and/or multi-functional in order to adjust the rheological properties for inkjet printing.

In embodiments, the monomers may include, for example, hexanedioic acid, bis[4-(ethenyloxy)butyl]ester, bis[4-(vinyloxy)butyl]adipate, 1,3-benzenedicarboxylic acid, bis[4-(ethenyloxy)butyl]ester, 4-(vinyloxy)butyl stearate, 4-(vinyloxy)butyl benzoate, 4-(vinyloxymethyl)cyclohexylmethyl benzoate, vinyl octadecyl ether, vinyl iso-octyl ether, 1,2,4-benzenetricarboxylic acid, tris[4-(ethenyloxy)butyl]ester, 3,4-epoxycyclohexylmethyl-3,4-epoxycyclohexanecarboxylate, and the like.

In embodiments, the amount of the cationically curable compound included in the composition may be, for example, in the range of from about 20% to about 90% by weight of the composition. In other embodiments, the amount of the cationically curable compound included in the composition may be, for example, in the range of from about 30% to about 80%, or from about 40% to about 60% by weight of the composition.

Cationic Photoinitiator

In embodiments, the composition comprises a cationic photoinitiator, which may photochemically initiate the polymerization of the cationically curable compound. The cationic photoinitiator may absorb radiation at a wavelength and catalyzes a reaction as a result. Any suitable cationic photoinitiator may be used. For example, the cationic photoinitiator may be triarylsulphonium or diaryliodonium salts, many of which are commercially available. Other cationic photoinitiators include aryldiazonium salts, triarylselenonium salts, dialkylphenacylsulphonium salts, triarylsulphoxonium salts, aryloxydiarylsulphonoxonium salts, and dialkylphenacylsulphoxonium salts. The salts are formed with ions such as BF₄⁻, PF₆⁻, AsF₆⁻, SbF₆⁻, CF₃SO₃⁻, etc. Substitution is often introduced to the aryl groups in order to increase the solubility of the initiators in nonpolar media. Other specific examples of the cationic photoinitiators that may be mentioned include bis[4-(diphenylsulphonio)-phenyl]sulphide bis-hexafluorophosphate, bis[4-di(4-(2-hydroxyethyl)phenyl)sulphonio-phenyl]sulphide bis-hexafluorophosphate, bis[4-di(4-(2-hydroxyethyl)phenyl)sulphonio-phenyl]sulphide bishexafluoroantimonate, 4-methylphenyl-(4-(2-methylpropyl)phenyl)iodonium hexafluorophosphate, (4-bromophenyl)diphenylsulfonium triflate, (4-phenylthiophenyl)diphenylsulfonium triflate, and R-gen® BF-1172 (obtained from Chitec Chemical Co., Ltd., Taiwan).

The cationic photoinitiator may be used in amounts of about 20% or less by weight of the composition. In some embodiments, the cationic photoinitiator is from about 0.5% to about 10% by weight of the composition. The cationic photoinitiator should be stable up to at least the jetting temperature of the composition so as not to lose effectiveness following jetting and/or not to be prematurely reactive at the elevated jetting temperature.

The radiation to cationically cure the compositions may be provided by any of a variety of techniques, including but not limited to techniques making use of a xenon lamp, laser light, microwave energized mercury lamps, mercury arc lamps, light emitting diodes, filtered light transported via light pipes from a D or H bulb, etc. The curing light may be filtered, if desired or necessary.

The curing of the ink following transfer to the image receiving substrate may be substantially complete to complete, i.e., at least about 75% of the cationically curable monomer is cured (reacted and/or crosslinked). This allows the composition to be substantially hardened.

Radically Curable Compound

In embodiments, the composition comprises a radically curable compound, that is, a compound including at least one radically polymerizable moiety.

Suitable radically curable compounds may include radically curable (polymerizable) monomers or oligomers. In embodiments, the radically curable compound may comprise an acrylate. Examples of the radically curable compound may include propoxylated neopentyl glycol diacrylate (such as SR-9003 from Sartomer), diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, isobornyl (meth)acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, propoxylated glycerol triacrylate, isobornyl methacrylate, lauryl acrylate, lauryl methacrylate, neopentyl glycol propoxylate methylether monoacrylate, isodecylmethacrylate, caprolactone acrylate, 2-phenoxyethyl acrylate, isooctylacrylate, isooctylmethacrylate, mixtures thereof and the like. As relatively non-polar monomers, examples may include isodecyl(meth)acrylate, caprolactone acrylate, 2-phenoxyethyl acrylate, isooctyl(meth)acrylate, butyl acrylate, mixture thereof, and the like. In addition, multifunctional acrylate monomers/oligomers may be used not only as reactive diluents, but also as materials that can increase the cross-link density of the cured image, thereby enhancing the toughness of the cured images.

In embodiments, multifunctional acrylate and methacrylate monomers and oligomers may be included in the composition as reactive diluents and as materials that can increase the crosslink density of the cured image, thereby enhancing the toughness of the cured images. Further, monomer(s) and/or oligomer(s) may also be added to tune the plasticity or elasticity of the cured objects. Examples of suitable multifunctional acrylate and methacrylate monomers and oligomers may include pentaerythritol tetraacrylate, pentaerythritol tetramethacrylate, 1,2-ethylene glycol diacrylate, 1,2-ethylene glycol dimethacrylate, 1,6-hexanediol diacrylate (available from Sartomer Co. Inc. as SR238), 1,6-hexanediol dimethacrylate, 1,12-dodecanol diacrylate, 1,12-dodecanol dimethacrylate, tris(2-hydroxy ethyl) isocyanurate triacrylate, propoxylated neopentyl glycol diacrylate (available from Sartomer Co. Inc. as SR 9003), neopentyl glycol diacrylate esters (available from Sartomer Co. Inc. as SR247), 1,4-butanediol diacrylate (BDDA, available from Sartomer Co. Inc. as SR213), tripropylene glycol diacrylate, dipropylene glycol diacrylate, dioxane glycol diacrylate (DOGDA, available from Sartomer Co. In. as CD536), amine modified polyether acrylates (available as PO 83 F, LR 8869, and/or LR 8889 (all available from BASF Corporation), trimethylolpropane triacrylate, ethoxylated trimethylolpropane triacrylate (available from Sartomer Co. Inc. as SR454), glycerol propoxylate triacrylate, dipentaerythritol pentaacrylate, dipentaerythritol hexaacrylate, ethoxylated pentaerythritol tetraacrylate (available from Sartomer Co. Inc. as SR 494), and the like, as well as mixtures and combinations thereof.

The reactive diluent may be added in any desired or effective amount. For example, the reactive diluent may be added in an amount of from about 1 to about 80% by weight of the composition, such as in the range of from about 10 to about 70%, or from about 30 to about 50%, by weight of the composition.

Radical Photoinitiator

In embodiments, the composition comprises a radical photoinitiator, which may photochemically initiate the polymerization of the radically curable compound.

As the radical photoinitiator, a photoinitiator that absorbs radiation, for example UV light radiation, to initiate curing of the curable components of the composition, may be used. Examples of the radical photoinitiator include benzophenones, benzoin ethers, benzil ketals, α-hydroxyalkylphenones, α-alkoxyalkylphenones, α-aminoalkylphenones, and acylphosphine photoinitiators sold under the trade designations of IRGACURE and DAROCUR (available from BASF). Further examples of suitable photoinitiators include 2,4,6-trimethylbenzoyldiphenylphosphine oxide (available as LUCIRIN TPO from BASF); 2,4,6-trimethylbenzoylethoxyphenylphosphine oxide (available as LUCIRIN TPO-L from BASF); bis(2,4,6-trimethylbenzoyl)-phenyl-phosphine oxide (available as IRGACURE 819 from BASF) and other acyl phosphines; 2-methyl-1-(4-methylthio)phenyl-2-(4-morphorlinyl)-1-propanone (available as IRGACURE 907 from BASF) and 1-(4-(2-hydroxyethoxy)phenyl)-2-hydroxy-2-methylpropan-1-one (available as IRGACURE 2959 from BASF); 2-benzyl 2-dimethylamino 1-(4-morpholinophenyl) butanone-1 (available as IRGACURE 369 from BASF); 2-hydroxy-1-(4-(4-(2-hydroxy-2-methylpropionyl)-benzyl)-phenyl)-2-methylpropan-1-one (available as IRGACURE 127 from BASF); 2-dimethylamino-2-(4-methylbenzyl)-1-(4-morpholin-4-ylphenyl)-butanone (available as IRGACURE 379 from BASF); titanocenes; isopropylthioxanthone (available as Darocur ITX from BASF); 1-hydroxy-cyclohexylphenylketone; benzophenone; 2,4,6-trimethylbenzophenone; 4-methylbenzophenone; 2,4,6-trimethylbenzoylphenylphosphinic acid ethyl ester; oligo(2-hydroxy-2-methyl-1-(4-(1-methylvinyl)phenyl) propanone); 2-hydroxy-2-methyl-1-phenyl-1-propanone; benzyl-dimethylketal; and mixtures thereof. In embodiments, any known photoinitiator that initiates free-radical reaction upon exposure to a desired wavelength of radiation such as UV light may be used.

In embodiments, the amount of the radical photoinitiator included in the composition may be, for example, in the range of from about 0.5% to about 15% by weight of the composition. In other embodiments, the amount of the radical photoinitiator included in the composition may be, for example, in the range of from about 1% to about 12%, or from about 2% to about 10% by weight of the composition.

Reactive Wax

The composition may optionally comprise a reactive wax. In embodiments, the reactive wax may comprise a curable wax component that is miscible with the other components and that will polymerize with the curable monomer to form a polymer. Inclusion of the wax promotes an increase in viscosity of the composition as it cools from the jetting temperature.

Exemplary waxes include those that are functionalized with curable groups. In embodiments, the curable groups may include, acrylate, methacrylate, alkene, allylic ether, epoxide, oxetane, and the like. These waxes may be synthesized by the reaction of a wax equipped with a transformable functional group, such as carboxylic acid or hydroxyl.

Suitable examples of hydroxyl-terminated polyethylene waxes that may be functionalized with a curable group include, for example, mixtures of carbon chains with the structure CH₃—(CH₂)ₙ—CH₂OH, where there is a mixture of chain lengths, n, where the average chain length is, in embodiments, in the range of from about 16 to about 50, and linear low molecular weight polyethylene, of similar average chain length. Suitable examples of such waxes include, UNILIN® 350, UNILIN® 425, UNILIN® 550 and UNILIN® 700 with Mn approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Specific embodiments of Guerbet alcohols include those containing from about 16 to about 36 carbons, many of which are commercially available from Jarchem Industries Inc., Newark, N.J. In embodiments, PRIPOL® 2033 is selected, PRIPOL® 2033 being a C-36 dimer diol mixture including isomers of the formula

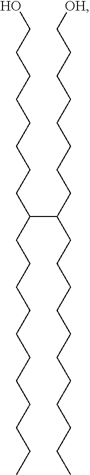

as well as other branched isomers which may include unsaturations and cyclic groups, available from Uniqema, New Castle, Del. Further information on C36 dimer diols of this type is disclosed in, for example, “Dimer Acids,” Kirk-Othmer Encyclopedia of Chemical Technology, Vol. 8, 4th Ed. (1992), pp. 223 to 237, the disclosure of which is totally incorporated herein by reference. These alcohols may be reacted with carboxylic acids equipped with UV curable moieties to form reactive esters. Examples of these acids include acrylic and methacrylic acids, available from Sigma-Aldrich Co. Specific curable monomers include acrylates of UNILIN® 350, UNILIN® 425, UNILIN® 550 and UNILIN® 700.

Suitable examples of carboxylic acid-terminated polyethylene waxes that may be functionalized with a curable group include mixtures of carbon chains with the structure CH₃—(CH₂)ₙ—COOH, where there is a mixture of chain lengths, n, where the average chain length is in selected embodiments in the range of from about 16 to about 50, and linear low molecular weight polyethylene, of similar average chain length. Suitable examples of such waxes include UNICID® 350, UNICID® 425, UNICID® 550 and UNICID® 700 with Mn equal to approximately 390, 475, 565 and 720 g/mol, respectively. Other suitable waxes have a structure CH₃—(CH₂)ₙ—COOH, such as hexadecanoic or palmitic acid with n=14, heptadecanoic or margaric or daturic acid with n=15, octadecanoic or stearic acid with n=16, eicosanoic or arachidic acid with n=18, docosanoic or behenic acid with n=20, tetracosanoic or lignoceric acid with n=22, hexacosanoic or cerotic acid with n=24, heptacosanoic or carboceric acid with n=25, octacosanoic or montanic acid with n=26, triacontanoic or melissic acid with n=28, dotriacontanoic or lacceroic acid with n=30, tritriacontanoic or ceromelissic or psyllic acid, with n=31, tetratriacontanoic or geddic acid with n=32, pentatriacontanoic or ceroplastic acid with n=33. Guerbet acids, characterized as 2,2-dialkyl ethanoic acids, are also suitable compounds. Selected Guerbet acids include those containing from about 16 to about 36 carbons, many of which are commercially available from Jarchem Industries Inc., Newark, N.J. PRIPOL® 1009 (C-36 dimer acid mixture including isomers of the formula

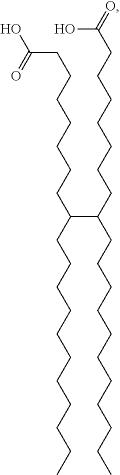

as well as other branched isomers which may include unsaturations and cyclic groups, available from Uniqema, New Castle, Del.; further information on C36 dimer acids of this type is disclosed in, for example, “Dimer Acids,” Kirk-Othmer Encyclopedia of Chemical Technology, Vol. 8, 4th Ed. (1992), pp. 223 to 237, the disclosure of which is totally incorporated herein by reference) may also be used. These carboxylic acids may be reacted with alcohols equipped with UV curable moieties to form reactive esters. Examples of these alcohols include 2-allyloxyethanol from Sigma-Aldrich Co.;

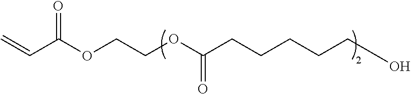

SR495B from Sartomer Company, Inc.;

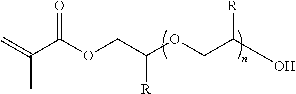

CD572 (R═H, n=10) and SR604 (R=Me, n=4) from Sartomer Company, Inc.

In embodiments, the optional curable wax is included in the composition in an amount of from about 1 to about 25% by weight of the composition, such as from about 2 to about 20% by weight of the composition, or from about 2.5 to about 15% by weight of the composition.

The curable monomer or prepolymer and curable wax together may form more than about 50% by weight of the composition, or more than about 70% by weight of the ink, or more than about 80% by weight of the composition.

Gellant

The composition may comprise any suitable gellant. The gellants function to dramatically increase the viscosity of the composition vehicle and composition within a desired temperature range. In particular, the gellant forms a semi-solid gel in the composition vehicle at temperatures below the specific temperature at which the composition is jetted. The semi-solid gel phase is a physical gel that exists as a dynamic equilibrium comprised of one or more solid gellant molecules and a liquid solvent. The semi-solid gel phase is a dynamic networked assembly of molecular components held together by non-covalent bonding interactions such as hydrogen bonding, Van der Waals interactions, aromatic non-bonding interactions, ionic or coordination bonding, London dispersion forces, and the like; which upon stimulation by physical forces such as temperature or mechanical agitation or chemical forces such as pH or ionic strength, can reversibly transition from liquid to semi-solid state at the macroscopic level. The compositions exhibit a thermally reversible transition between the semi-solid gel state and the liquid state when the temperature is varied above or below the gel-phase transition. This reversible cycle of transitioning between semi-solid gel phase and liquid phase can be repeated many times in the composition. Mixtures of one or more gellants may be used to effect the phase-change transition.

The phase change nature of the gellant may be used to cause a rapid viscosity increase in the composition following jetting of the composition to the substrate. In particular, jetted ink droplets of the composition may be pinned into position on a receiving substrate with a cooler temperature than the ink-jetting temperature of the composition through the action of a phase-change transition. The phase change nature of the gellant also allows build-up of the three dimensional objects in multiple printing steps during digital fabrication or three dimensional printing.

The temperature at which the composition forms the gel state is any temperature below the jetting temperature of the composition, for example any temperature that is about 10° C. or more below the jetting temperature of the composition. There is a rapid and large increase in the viscosity of the composition upon cooling from the jetting temperature at which the composition is in a liquid state, to the gel transition temperature, at which the composition converts to the gel state. The composition of some embodiments may show at least a 10^{2.5}-fold increase in viscosity.

Suitable gellants may gel the cationically curable compounds and/or the radically curable compounds in the composition quickly and reversibly, and demonstrate a narrow phase-change transition, for example within a temperature range of from about 20° C. to about 85° C. The gel state of exemplary compositions should exhibit a minimum of about 10^{2.5} mPa·s, such as about 10³ mPa·s, increase in viscosity at substrate temperatures, for instance, in the range of from about 30° C. to about 70° C., compared to the viscosity at the jetting temperature. In some embodiments, the gellant-containing compositions rapidly increase in viscosity within about 5° C. to about 10° C. below the jetting temperature and ultimately reach a viscosity above about 10⁴ times the jetting viscosity, for example about 10⁵ times the jetting viscosity.

Suitable gellants include a curable gellant comprised of a curable amide, a curable polyamide-epoxy acrylate component and a polyamide component; a curable composite gellant comprised of a curable epoxy resin and a polyamide resin; mixtures thereof and the like, as disclosed in U.S. application Ser. No. 12/474,946, the disclosure of which is hereby incorporated herein by reference in its entirety. Inclusion of the gellant in the composition permits the composition to be applied over a substrate, such as on one or more portions of the substrate and/or on one or more portions of an image previously formed on the substrate, without excessive penetration into the substrate because the viscosity of the composition is quickly increased as the composition cools following application.

The gellants may be amphiphilic in nature to improve wetting when the composition is used over a substrate having silicone or other oil thereon. The term “Amphiphilic” refers, for example, to molecules that have both polar and non-polar parts of the molecule. For example, the gellants may have long non-polar hydrocarbon chains and polar amide linkages.

Amide gellants include those described in U.S. patent application Ser. No. 12/765,148, U.S. Patent Application Publication No. 2008/0122914, and U.S. Pat. Nos. 7,276,614 and 7,279,587, the entire disclosures of which are incorporated herein by reference.

The amide gellant may be a compound of the following formula (I):

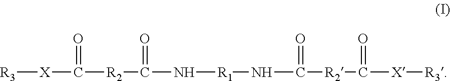

In formula (I), R₁ may be:

(i) an alkylene group (wherein an alkylene group is a divalent aliphatic group or alkyl group, including linear and branched, saturated and unsaturated, cyclic and acyclic, and substituted and unsubstituted alkylene groups; and wherein heteroatoms, such as oxygen, nitrogen, sulfur, silicon, phosphorus, boron, and the like either may or may not be present in the alkylene group) having from about 1 to about 12 carbon atoms, such as from about 1 to about 8, or from about 1 to about 5 carbon atoms;

(ii) an arylene group (wherein an arylene group is a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group) having from about 1 to about 15 carbon atoms, such as from about 3 to about 10, or from about 5 to about 8 carbon atoms;

(iii) an arylalkylene group (wherein an arylalkylene group is a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group) having from about 6 to about 32 carbon atoms, such as from about 6 to about 22, or from about 6 to about 12 carbon atoms; or

(iv) an alkylarylene group (wherein an alkylarylene group is a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group) having from about 5 to about 32 carbon atoms, such as from about 6 to about 22, or from about 7 to about 15 carbon atoms.

Unless otherwise specified, the substituents on the substituted alkyl, aryl, alkylene, arylene, arylalkylene, and alkylarylene groups disclosed above and hereinafter may be selected from halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like. Optionally, two or more substituents may be joined together to form a ring.

In formula (I), R₂ and R₂′ each, independently of the other, may be:

(i) alkylene groups having from about 1 to about 54 carbon atoms, such as from about 1 to about 48, or from about 1 to about 36 carbon atoms;

(ii) arylene groups having from about 5 to about 15 carbon atoms, such as from about 5 to about 13, or from about 5 to about 10 carbon atoms;

(iii) arylalkylene groups having from about 6 to about 32 carbon atoms, such as from about 7 to about 33, or from about 8 to about 15 carbon atoms; or

(iv) alkylarylene groups having from about 6 to about 32 carbon atoms, such as from about 6 to about 22, or from about 7 to about 15 carbon atoms.

In formula (I), R₃ and R₃′ each, independently of the other, may be either:

(a) photoinitiating groups, such as groups derived from 1-(4-(2-hydroxyethoxy)phenyl)-2-hydroxy-2-methylpropan-1-one, of the formula (II):

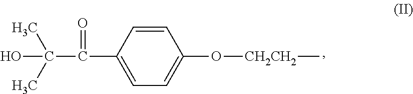

groups derived from 1-hydroxycyclohexylphenylketone, of the formula (III):

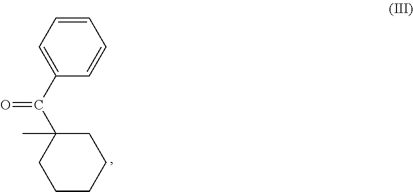

groups derived from 2-hydroxy-2-methyl-1-phenylpropan-1-one, of the formula (IV):

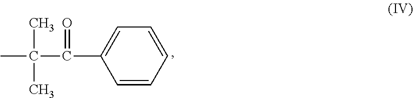

groups derived from N,N-dimethylethanolamine or N,N-dimethylethylenediamine, of the formula (V):

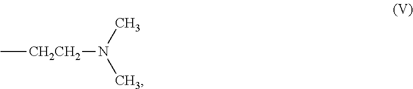

or the like; or

(b) a group which is:
(i) an alkyl group (wherein an alkyl group includes linear and branched, cyclic and acyclic, and substituted and unsubstituted alkyl groups, and wherein hetero atoms such as oxygen, nitrogen, sulfur, silicon, phosphorus, boron, and the like, may optionally be present in the alkyl group) having from about 2 to about 100 carbon atoms, such as from about 3 to about 60, or from about 4 to about 30 carbon atoms;
(ii) an aryl group (wherein an aryl group includes substituted and unsubstituted aryl groups) having from about 5 to about 100 carbon atoms, such as from about 5 to about 60, or from about 6 to about 30 carbon atoms, such as phenyl or the like;
(iii) an arylalkyl group having from about 5 to about 100 carbon atoms, such as from about 5 to about 60, or from about 6 to about 30 carbon atoms, such as benzyl or the like; or
(iv) an alkylaryl group having from about 5 to about 100 carbon atoms, such as from about 5 to about 60, or from about 6 to about 30 carbon atoms, such as tolyl or the like.

In addition, in formula (I), X and X′ each, independently of the other, may be an oxygen atom or a group of the formula —NR₄—, wherein R₄ is:

(i) a hydrogen atom;

(ii) an alkyl group having from about 5 to about 100 carbon atoms, such as from about 5 to about 60 or from about 6 to about 30 carbon atoms;

(iii) an aryl group having from about 5 to about 100 carbon atoms, such as from about 5 to about 60 or from about 6 to about 30 carbon atoms;

(iv) an arylalkyl group having from about 5 to about 100 carbon atoms, such as from about 5 to about 60 or from about 6 to about 30 carbon atoms; or

(v) an alkylaryl group having from about 5 to about 100 carbon atoms, such as from about 5 to about 60 or from about 6 to about 30 carbon atoms.

Further details may be found, for example, in U.S. Pat. Nos. 7,279,587 and 7,276,614, the entire disclosures of which are totally incorporated herein by reference.

The gellant may comprise one of or a mixture of formulas (VI), (VII), or (VIII):

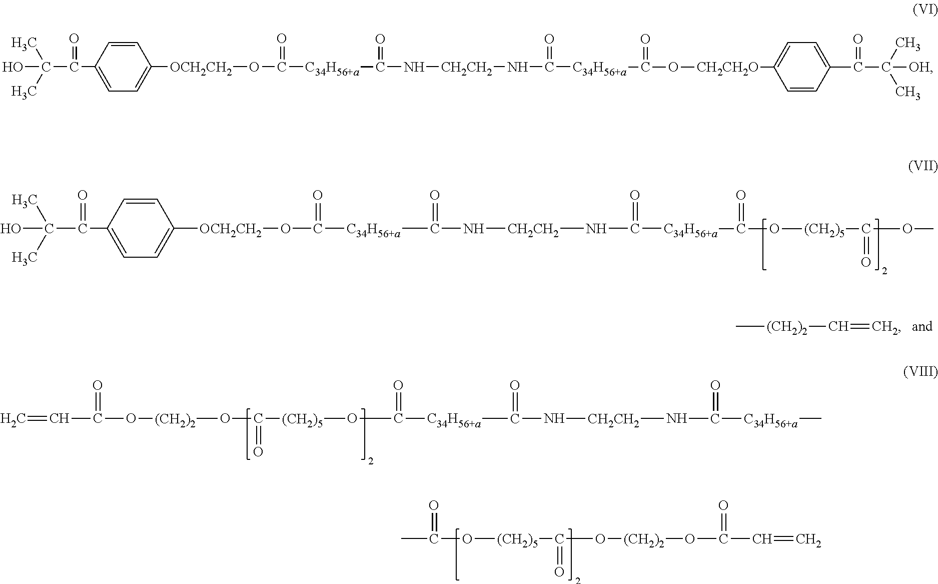

where —C₃₄H₅₆₊ₐ— represents a branched alkylene group that may include unsaturations and cyclic groups, and the variable “a” is an integer from 0 to about 12.

The composition may include the gellant in any suitable amount, such as from about 1 to about 30 wt % of the composition, or from about 2 to about 20 wt %, or from about 5 to about 15 wt %.

The gellant may comprise a compound of the formula (XII):

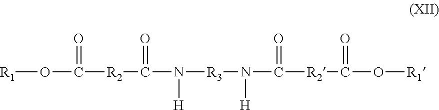

where:

R₁ and R₁′ are the same and are selected from the following non-reactive aromatic groups:

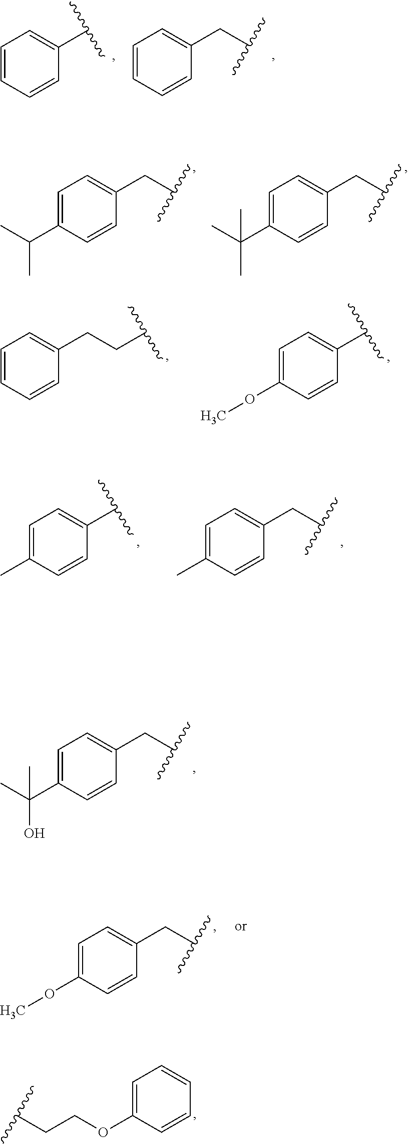

wherein [symbol] represents the point of attachment of the R₁ and R₁′ group.

In some embodiments, R₁ and R₁′ are the same and are selected from the formulas:

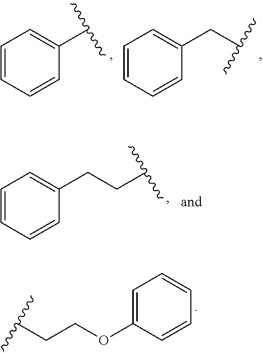

In one specific embodiment, R₁ and R₁′ are each of the formula

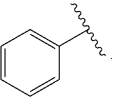

In another specific embodiment, R₁ and R₁′ are each of the formula

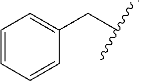

In yet another specific embodiment, R₁ and R₁′ are each of the formula

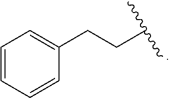

In still another specific embodiment, R₁ and R₁′ are each of the formula

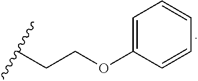

R₂ and R₂′ are the same or different, and are each independently selected from:

(i) alkylene groups having from about 2 to about 100 carbon atoms, such as from at least about 2 to at least about 36 carbon atoms, or no more than about 100, or no more than about 60, or no more than about 50 carbon atoms, or such as having about 36 carbon atoms;

(ii) arylene groups having from about 5 to about 100 carbon atoms, such as, for example, at least about 5 or at least about 6 carbon atoms, or no more than about 100, or no more than about 60, or no more than about 50 carbon atoms;

(iii) arylalkylene groups having from about 6 to about 100 carbon atoms, such as, for example, at least about 6 or at least about 7 carbon atoms, or no more than about 100, or no more than about 60, or no more than about 50 carbon atoms; and

(iv) alkylarylene groups having from about 6 to about 100 carbon atoms, such as, for example, at least 6 or at least about 7 carbon atoms, or no more than about 100, or no more than about 60, or no more than about 50 carbon atoms.

In some embodiments, R₂ and R₂′ are both alkylene groups, which can be linear or branched, saturated or unsaturated, cyclic or acyclic, and substituted alkylene groups, and hetero atoms may optionally be present in the alkylene group. In some other embodiments, R₂ and R₂′ are both saturated alkylene groups. In other embodiments, R₂ and R₂′ are both unsubstituted alkylene groups. In some embodiments, R₂ and R₂′ are each of the formula

—C₃₄H₅₆₊ₐ—

and are branched alkylene groups that may include unsaturations and cyclic groups, where a is an integer of from 0 to about 12. In some other embodiments, R₂ and R₂′ include isomers of the formula

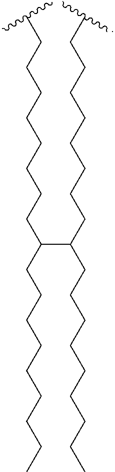

R₃ is:

(i) an alkylene group having from about 2 to about 80 carbon atoms, such as, for example, at least about 2 carbon atoms, or no more than about 80 carbon atoms, or no more than about 60 carbon atoms, or no more than about 50 carbon atoms, or no more than about 36 carbon atoms;

(ii) an arylene group having from about 2 to about 50 carbon atoms, such as, for example, about 2 carbon atoms, or having no more than about 5 or about 6 carbon atoms, or no more than about 50 carbon atoms, or no more than about 25 carbon atoms, or no more than about 18 carbon atoms;

(iii) an arylalkylene group having from about 6 to about 50 carbon atoms such as, for example, at least about 6 or about 7 carbon atoms, or no more than about 50, or no more than about 36 carbon atoms, or no more than about 18 carbon atoms; or

(iv) an alkylarylene group having from about 6 to about 50 carbon atoms, such as, for example, at least about 6 or 7 carbon atoms, or no more than about 50, or no more than about 36 carbon atoms, or no more than about 18 carbon atoms.

In some embodiments, R₃ is a linear or branched alkylene group, which can be saturated or unsaturated, substituted or unsubstituted alkylene groups, and where hetero atoms may optionally be present in the alkylene group. In a specific embodiment, R₃ is an ethylene group

—CH₂CH₂—.

In embodiments where R₁ and R₁′ are a single species end-capping both ends of the gellant compound, a single gellant product is provided, rather than a mixture, thereby eliminating the need for complex post-reaction purification and processing. The gellant composition functionalized with identical aromatic end-cap molecules provides enhanced spectral transmission and gelation properties, such as reduced ultraviolet absorbance, higher thermal stability, and higher ultimate viscosity over prior gellant compounds.

Aromatic end-capped gellant compounds have reduced ultraviolet absorbance that enables more efficient ultraviolet cure of the composition prepared with the present gellants. In certain embodiments, the compounds herein provide an absorbance of from about 0 to about 0.8, or from about 0 to about 0.7, or from about 0 to about 0.6 at a wavelength of from about 230 to about 400 nanometers.

In embodiments where R₁ and R₁′ are the same non-reactive end-cap molecule, the resultant gellant compound exhibits high thermal stability. With respect to thermal stability, heating of a conventional gellant overnight in an oven at 85° C. yields a product that is incompletely soluble in monomer. In embodiments herein, gellants with aromatic end-cap functionality are stable for at least about 8 weeks in an oven at 85° C. and the material is freely soluble in monomer. The term “stable” refers, for example, to no crosslinking or decomposition of the material, such as a gellant material, and it remains completely soluble in monomer. The use of a single end-cap species results in cleaner product synthesis with fewer side products.

In certain embodiments, the compounds herein provide a complex viscosity of from about 10⁴ centipoise (cps) to about 10⁸ cps, or from about 10⁵ cps to about 10′ cps, or from about 10⁵ cps to about 10⁶ cps at a temperature of from about 10 to about 50° C.

Specific gellant compounds may be of one of the following formulas:

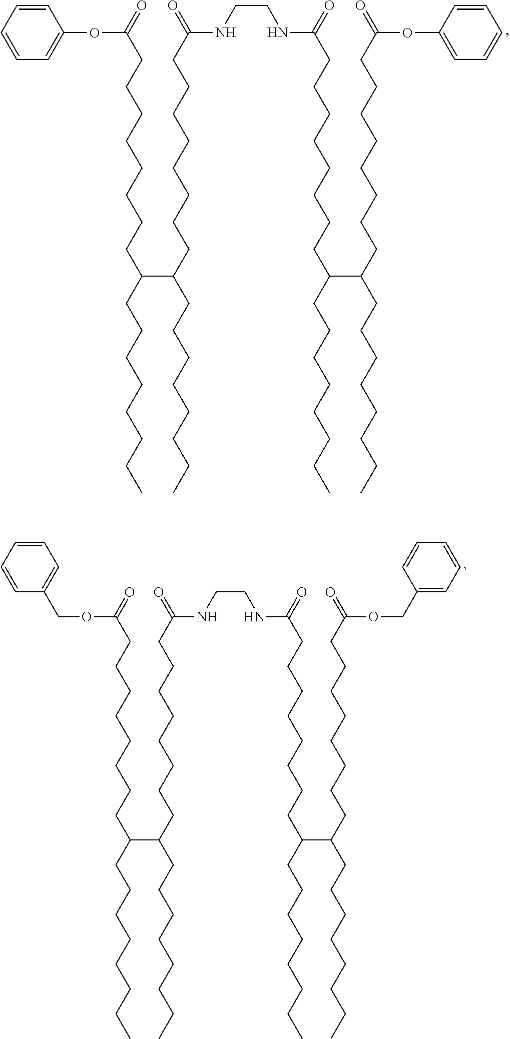

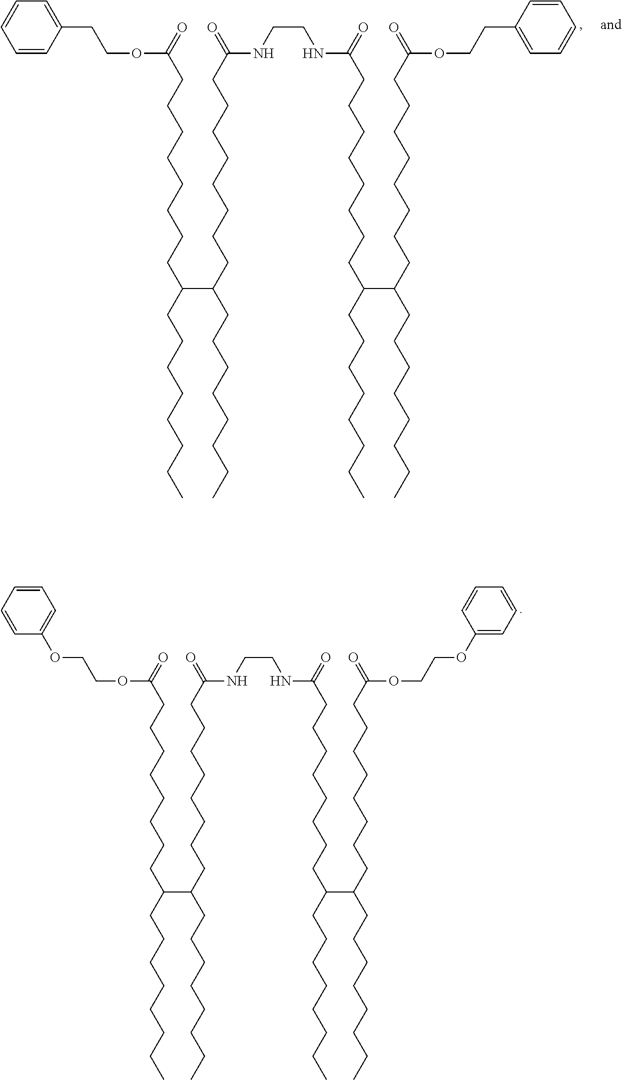

The gellant may comprise a compound of the formula (XI):

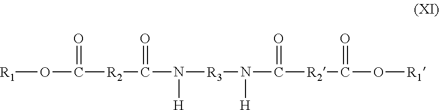

where R₂, R₂′ and R₃ are as described above for formula (X), and R₁ and R₁′ can be the same or different, and each, independently of the other, is:

(i) an alkyl group having a least one ethylenic unsaturation therein and having at least about 2 carbon atoms, at least about 3 carbon atoms, or at least about 4 carbon atoms, or no more than about 100 carbon atoms, no more than about 60 carbon atoms, or no more than about 30 carbon atoms;

(ii) an arylalkyl group having at least one ethylenic unsaturation therein, and having from about 6 to about 100 carbon atoms, such as, for example, at least about 6 or 7 carbon atoms, or no more than about 100 carbon atoms, no more than about 60 carbon atoms, or no more than about 30 carbon atoms;

(iii) an alkylaryl group having at least one ethylenic unsaturation therein, having about 6 to about 100 carbon atoms, such as at least about 6 or at least about 7 carbon atoms, or not more than about 100 carbon atoms, no more than about 60 carbon atoms, or no more than about 30 carbon atoms; or

(iv) a non-reactive aromatic group;

provided that at least one of R₁ and R₁′ is a non-reactive aromatic group, and provided that neither of R₁ or R₁′ is a photoinitiator group.

One of R₁ or R_{1′} may be selected from the following formulas:

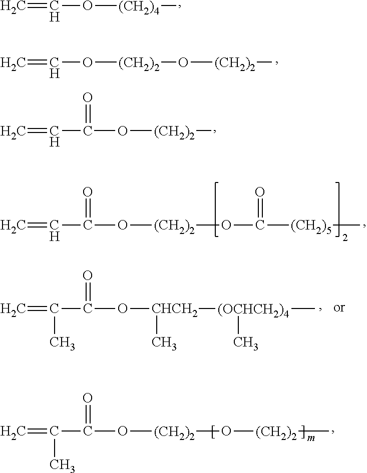

where “m” is an integer representing the number of repeating (O—(CH₂)₂ units. The variable “m” may be an integer from about 1 to about 10, or “m” may be an integer greater than about 10.

Specific examples of suitable gellant compounds include the following formulas:

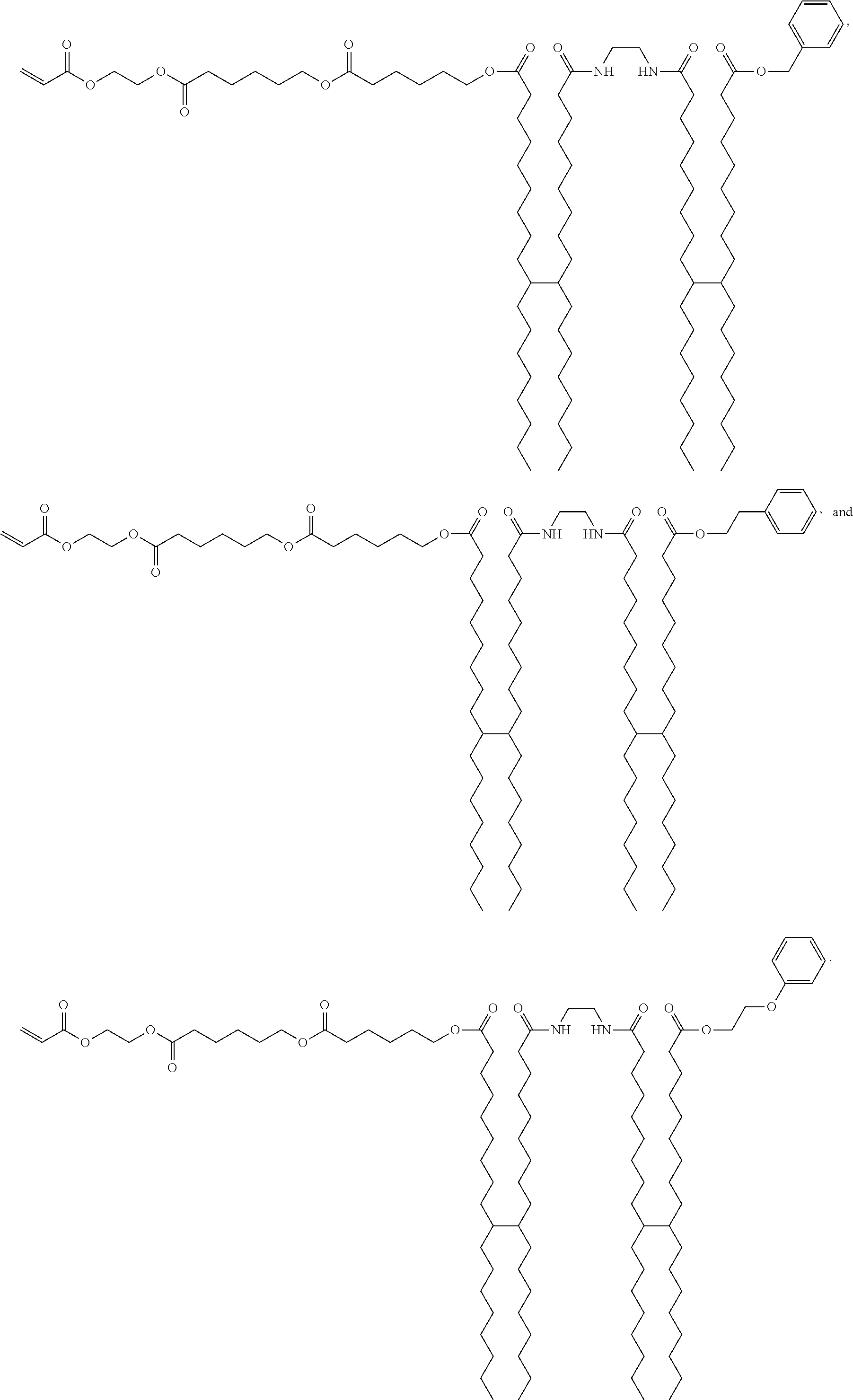

Colorant

The composition may optionally comprise a colorant. The optional colorant, if present, may be present in a colored marking material in any desired amount, for example from about 0.5 to about 50% by weight of the composition, such as about 1 to about 20% or from about 1 to about 10%, by weight of the composition.

Any suitable colorant may be used in embodiments herein, including dyes, pigments, or combinations thereof. As colorants, examples may include any dye or pigment capable of being dispersed or dissolved in the vehicle. Examples of suitable pigments include, for example, Paliogen Violet 5100 (BASF); Paliogen Violet 5890 (BASF); Heliogen Green L8730 (BASF); Lithol Scarlet D3700 (BASF); SUNFAST® Blue 15:4 (Sun Chemical 249-0592); HOSTAPERM Blue B2G-D (Clariant); Permanent Red P-F7RK; HOSTAPERM Violet BL (Clariant); Lithol Scarlet 4440 (BASF); Bon Red C (Dominion Color Company); Oracet Pink RF (Ciba); Paliogen Red 3871 K (BASF); SUNFAST® Blue 15:3 (Sun Chemical 249-1284); Paliogen Red 3340 (BASF); SUNFAST® Carbazole Violet 23 (Sun Chemical 246-1670); Lithol Fast Scarlet L4300 (BASF); Sunbrite Yellow 17 (Sun Chemical 275-0023); Heliogen Blue L6900, L7020 (BASF); Sunbrite Yellow 74 (Sun Chemical 272-0558); SPECTRA PAC® C Orange 16 (Sun Chemical 276-3016); Heliogen Blue K6902, K6910 (BASF); SUNFAST® Magenta 122 (Sun Chemical 228-0013); Heliogen Blue D6840, D7080 (BASF); Sudan Blue OS (BASF); Neopen Blue FF4012 (BASF); PV Fast Blue B2GO1 (Clariant); Irgalite Blue BCA (Ciba); Paliogen Blue 6470 (BASF); Sudan Orange G (Aldrich); Sudan Orange 220 (BASF); Paliogen Orange 3040 (BASF); Paliogen Yellow 152, 1560 (BASF); Lithol Fast Yellow 0991 K (BASF); Paliotol Yellow 1840 (BASF); Novoperm Yellow FGL (Clariant); Lumogen Yellow D0790 (BASF); Suco-Yellow L1250 (BASF); Suco-Yellow D1355 (BASF); Suco Fast Yellow D1355, D1351 (BASF); Hostaperm Pink E 02 (Clariant); Hansa Brilliant Yellow 5GX03 (Clariant); Permanent Yellow GRL 02 (Clariant); Permanent Rubine L6B 05 (Clariant); Fanal Pink D4830 (BASF); Cinquasia Magenta (Du Pont), Paliogen Black L0084 (BASF); Pigment Black K801 (BASF); and carbon blacks such as REGAL 330™ (Cabot), Carbon Black 5250, Carbon Black 5750 (Columbia Chemical), mixtures thereof and the like. Examples of suitable dyes include Usharect Blue 86 (Direct Blue 86), available from Ushanti Color; Intralite Turquoise 8GL (Direct Blue 86), available from Classic Dyestuffs; Chemictive Brilliant Red 7BH (Reactive Red 4), available from Chemiequip; Levafix Black EB, available from Bayer; Reactron Red H8B (Reactive Red 31), available from Atlas Dye-Chem; D&C Red #28 (Acid Red 92), available from Warner-Jenkinson; Direct Brilliant Pink B, available from Global Colors; Acid Tartrazine, available from Metrochem Industries; Cartasol Yellow 6GF Clariant; Carta Blue 2GL, available from Clariant; and the like. Example solvent dyes include spirit soluble dyes such as Neozapon Red 492 (BASF); Orasol Red G (Ciba); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (Ciba); Orasol Black RLP (Ciba); Savinyl Black RLS (Clariant); Morfast Black Conc. A (Rohm and Haas); Orasol Blue GN (Ciba); Savinyl Blue GLS (Sandoz); Luxol Fast Blue MBSN (Pylam); Sevron Blue 5GMF (Classic Dyestuffs); Basacid Blue 750 (BASF), Neozapon Black X51 [C.I. Solvent Black, C.I. 12195] (BASF), Sudan Blue 670 [C.I. 61554] (BASF), Sudan Yellow 146 [C.I. 12700] (BASF), Sudan Red 462 [C.I. 260501] (BASF), mixtures thereof and the like.

The ink may also contain a pigment stabilizing surfactant or dispersant having portions or groups that have an excellent adsorption affinity for the various pigments used in the colored inks of the ink set, and also having portions or groups that allow for dispersion within the ink vehicle are desired. Selection of an appropriate dispersant for all of the colored inks of the ink set may require trial and error evaluation, capable by those of ordinary skill in the art, due to the unpredictable nature of dispersant/pigment combinations.

As example dispersants, random and block copolymers may be suitable. A particularly desirable block copolymer is an amino acrylate block copolymer, for example including an amino or amino acrylate block A and an acrylate block B, the acrylate portions permitting the dispersant to be stably and well dispersed in the ink vehicle while the amino portions adsorb well to pigment surfaces. Commercially available examples of block copolymer dispersants that have been found suitable for use herein are DISPERBYK-2001 (BYK Chemie GmbH) and EFKA 4340 (BASF).

In embodiments, the composition may be substantially free of colorant. The term “substantially free of colorant” refers, for example, to a composition that comprises a colorant present in an amount less than about 0.5% by weight of the composition. In embodiments, the composition may also optionally comprise other additives.

The ink vehicle of one or more inks of the ink set may contain additional optional additives. Optional additives may include surfactants, light stabilizers, which absorb incident UV radiation and convert it to heat energy that is ultimately dissipated, antioxidants, optical brighteners, which can improve the appearance of the image and mask yellowing, thixotropic agents, dewetting agents, slip agents, foaming agents, antifoaming agents, flow agents, other non-curable waxes, oils, plasticizers, binders, electrical conductive agents, fungicides, bactericides, organic and/or inorganic filler particles, leveling agents, which are agents that create or reduce different gloss levels, opacifiers, antistatic agents, dispersants, and the like.

The inks may include, as a stabilizer, a radical scavenger, such as IRGASTAB UV 10 (BASF). The inks may also include an inhibitor, such as a hydroquinone or monomethylether hydroquinone (MEHQ), to stabilize the composition by prohibiting or, at least, delaying, polymerization of the oligomer and monomer components during storage, thus increasing the shelf life of the composition.

Printing Apparatus and Process

In embodiments, the above exemplified compositions may be employed with any desired printing system including systems suitable for preparing three-dimensional objects, such as a solid object printer, piezoelectric ink jet printer (both with inks liquid at room temperature and with phase-change inks), acoustic ink jet printer (both with inks liquid at room temperature and with phase-change inks), and the like. In other embodiments, the ink materials may be used for manual preparation of three-dimensional objects, such as through the use of molds or by manual deposition of the ink material, to prepare a desired three-dimensional object.

In embodiments, a method of printing a three-dimensional object comprises: depositing the composition upon a surface, such as a print region surface; and curing the composition; thereby obtaining the three-dimensional object.

In embodiments, the method comprises digital fabrication or rapid prototyping.

In embodiments, curing is performed using light supplied to the composition by a variety of possible techniques, including but not limited to a UV, xenon lamp, laser light, microwave energized mercury bulb, filtered light transported via light pipes from a D or H bulb, light emitting diodes, mercury arc lamp etc. The curing light may be filtered, if desired or necessary, to remove lower wavelengths of light that might prematurely initiate the radical cure of the remainder of the composition.

Exposure to light can be accomplished with a variety of equipment. For example, large area exposures can be conducted using a F300S Ultraviolet Lamp System available from Fusion UV Systems Inc., Gaithersburg, Md. This system uses doped mercury lamps commonly designated as H, D, Q and V bulbs; the dopant determines the set of wavelengths the bulbs emit and all are available from Fusion UV. Light filters are sometimes used with the Fusion UV unit to eliminate light below 400 nm or below 450 nm wavelength. LED arrays from EXFO Photonic Solutions, Mississauga, ON can also be used. These consist of 100 diode elements arranged in a 5 mm by 5 mm square with one array emitting at 396 nm and a second array with emission centered at 470 nm. An 8 mm by 8 mm 100 element LED array emitting at 450 nm can also be employed. An EXFO Novacure 2100 unit can also be used with an 8 mm diameter light pipe and equipped with light filters to deliver either 320-500 nm wavelength light or 400-500 nm wavelength light.

The rheological properties of the digital fabrication material of the present disclosure may be tuned to achieve robust jetting at elevated temperatures (10-15 cPs) and a degree of mechanical stability (10⁵-10⁶ cPs) at ambient substrate temperatures (i.e. room temperature). The gel nature of the material at room temperature prevents spread or migration of the printed droplet and allows for facile build-up of 3-dimensional structures.

In embodiments, curing the composition is performed by dark cure or shadow cure. Cationic curing offers advantages over radical curing, at least radical curing alone, including providing to a colored or colorless composition any of increased thermal stability, insensitivity to oxygen, low shrinkage and opportunities for dark cure and/or shadow cure. Dark cure refers to the phenomenon in which polymerization continues after radiation is discontinued. It is enabled by the fact that cationic curing is initiated by photoacids and, therefore, does not undergo termination reactions, as radicals do. Shadow cure refers to the phenomenon in which active curing centers migrate after radiation is discontinued and, in the process, continue the polymerization process in areas that had not been exposed to radiation. Both dark and shadow curing offer the potential for an increased degree of polymerization over systems, which do not offer dark and/or shadow curing. Specifically, both dark and shadow curing offer the potential for an increased degree of polymerization in pigmented systems in which photons are reflected, scattered and/or absorbed by particles, preventing them from penetrating through the entire composition. Dark and shadow curing offer the potential for an increased degree of polymerization in three dimensional objects where the complex geometry may not allow all surfaces to be exposed to polymerization initiating radiation. Hybrid curable inks offer the speed of radical curing combined with the dark and/or shadow curing properties of cationic polymerization pathways.

In embodiments, an ink jet printing device as described in commonly assigned, co-pending U.S. patent application Ser. No. 11/683,011, incorporated by reference herein in its entirety, may be employed. The ink jet printing apparatus includes at least an ink jet print head and a print region surface toward which ink is jetted from the ink jet print head, wherein a height distance between the ink jet print head and the print region surface is adjustable. Therein, the ink jet print head is adjustable in spacing with respect to the print region surface so as to permit the ink jet print head to be moved from the a first position for regular height printing to a second height distance that is greater than (that is, the spacing between the ink jet print head and the print region surface is greater than) the first height distance. The second height distance is not fixed, and may be varied as necessary for a given printing. Moreover, the second height distance may itself be changed during a printing, as necessary. For example, it may be desirable to adjust the height distance from the first position to a second position as an image is built-up by the ink jet print head, and then as the image continues to be built-up, to adjust the ink jet print head from the second position to a third position in which the spacing from the print region surface is even further increased, and so on as necessary to complete build-up of the object.

In embodiments, the ink jet print head or target stage may be movable in three dimensions, x, y, and z, enabling the build up of an object of any desired size. Moreover, three dimensional objects may be formed with appropriate multiple passing of the ink jet print head over an area to achieve the desired object height and geometry. Jetting of ink from multiple different ink jets of the ink jet print head toward a same location of the image during a single pass may also be used to form raised height objects. As discussed below, in embodiments, each layer of ink may add from about 1 to about 6 mm in height to the image height. Knowing the total print height desired, the appropriate number of passes or jettings may be readily determined.

A controller may then control the ink jet print head to deposit the appropriate amount and/or layers of ink at locations of the image so as to obtain the image with the desired print heights and overall geometries therein.

The ink jet print head may support single color or full color printing. In full color printing, the ink jet print head typically includes different channels for printing the different colors. The ink jet print head may include four different sets of channels, for example one for each of cyan, magenta, yellow and black. In such embodiments, the ink jet print head is capable of printing either full color regular height prints when the ink jet print head is set at a minimum distance from the print region surface, or raised height prints of any color when the ink jet print head is at a distance greater than the minimum distance from the print region surface. Alternatively, a system may employ separate printheads and ink supply for each color or different material used.

The three-dimensional objects prepared herein may be free-standing parts or objects, rapid prototyping devices, raised structures on substrates, such as, for example, topographical maps, or other desired objects. Any suitable surface, substrate, recording sheet, or removable support, stage, platform, and the like, may be employed for depositing the three-dimensional objects thereon, including plain papers such as XEROX® 4024 papers, XEROX® Image Series papers, Courtland 4024 DP paper, ruled notebook paper, bond paper, silica coated papers such as Sharp Company silica coated paper, JuJo paper, HAMMERMILL LASERPRINT® paper, and the like, glossy coated papers such as XEROX® Digital Color Gloss, Sappi Warren Papers LUSTROGLOSS®, and the like, transparency materials, fabrics, textile products, plastics, polymeric films, inorganic substrates such as metals and wood, as well as meltable or dissolvable substrates, such as waxes or salts, in the case of removable supports for free-standing objects, and the like.

The hybrid composition when prepared as an ink composition to be used in the printing apparatus described above may be prepared by any desired or suitable method. For example, the ink ingredients may be mixed together, followed by heating, to a temperature in embodiments of from about 80° C. to about 120° C., and stirring until a homogeneous ink composition is obtained, followed by cooling the ink to ambient temperature (typically from about 20° C. to about 25° C.).

The ink compositions generally have melt viscosities at the jetting temperature (for example, the jetting temperature may be from about 50° C. to about 120° C., such as from about 60° C. to about 110° C., or from about 70° C. to about 90° C.) of from about 2 to about 30 centipoise, such as from about 5 to about 20 centipoise, or from about 7 to about 15 centipoise.

In embodiments, the inks are jetted at low temperatures, in particular at temperatures below about 110° C., such as from about 40° C. to about 110° C., or from about 50° C. to about 110° C., or from about 60° C. to about 90° C. In particular, jetted ink droplets may be pinned into position on a receiving substrate such as a final recording substrate, such as paper or transparency material that is maintained at a temperature cooler than the ink jetting temperature of the ink through the action of a phase-change transition in which the ink undergoes a significant viscosity change from a liquid state to a gel state (or semi-solid state).

In embodiments, the temperature at which the ink forms the gel state is any temperature below the jetting temperature of the ink, such as any temperature that is about 5° C. or more below the jetting temperature of the ink. In embodiments, the gel state may be formed at a temperature of from about 25° C. to about 100° C., such as from about 30° C. to about 70° C. A rapid and large increase in ink viscosity occurs upon cooling from the jetting temperature, at which the ink is in a liquid state, to the gel temperature, at which the ink is in the gel state. The viscosity increase is, in embodiments, at least a 10^{2.5}-fold increase in viscosity.

When the inks are in the gel state, the viscosity of the ink is in one embodiment at least about 10³ centipoise, and in another embodiment at least about 10^{4.5} centipoise, and in one embodiment no more than about 10⁹ centipoise, and in another embodiment no more than about 10^{6.5} centipoise. The preferred gel phase viscosity may vary with the print process. The gel viscosity may be controlled by ink formulation and substrate temperature. An additional benefit of the gel state for radiation curable inks is that higher viscosities of about 10³ to about 10⁴ centipoise can reduce oxygen diffusion in the ink, which in turn can lead to a faster rate of cure in free radical initiation. In the present system, the maximum viscosity reached exceeds these values (about 10⁵ to about 10⁶ centipoise).

In embodiments, successive layers of the curable ink may be deposited to form an object having a selected height and shape. For example, objects of from about 1 to about 10,000 micrometers in height. The successive layers of the curable ink may be deposited to a build platform or to a previous layer of solidified material in order to build up a three-dimensional object in a layer-wise fashion. In embodiments, objects of virtually any design may be created, from a micro-sized scale to a macro-sized scale and may include simple objects to objects having complex geometries. The ink jet materials and method herein further advantageously provide a non-contact, additive process (as opposed to subtractive process such as computer numerical control machining) providing the built-in ability to deliver metered amounts of the present ink materials to a precise location in time and space.

In embodiments, a thickness of the first and each successive layer of the phase-change ink composition may be controlled by selecting the desired droplet size to be ejected from the printhead. In embodiments, the volume of the droplet may be from about 5 pL to about 50 pL, which (depending on the specific composition of the droplet) may correspond to an individual layer thickness of from about 1 μm to about 50 μm. In embodiments, the volume of the droplet may be greater than about 1 pL, such as from about 1 pL to about 500 pL, or from about 2 pL to about 200 pL. In embodiments, thickness of one of the individual layers that make up the successively deposited layers may be greater than 0.1 μm, such as an individual layer thickness of from about 0.1 μm to about 100 μm, or from about 0.5 μm to about 50.

In embodiments, the present hybrid materials may display a gel consistency at room temperature to prevent spread or migration of the printed droplet and allows for facile build-up of three-dimensional structures. Although there are no limits to the height or overall size of an object that may be created, very large objects may require intermediate or more frequent curing in and/or during the deposition process. Due to the radiation curable nature of the present hybrid material, the printed object may be cured by exposure to ultraviolet radiation at any point in the fabrication process resulting in more robust objects with a high degree of mechanical strength. The term “curing” refers, for example, to the curable compounds in the ink undergoing an increase in molecular weight, such as during crosslinking, chain lengthening, or the like, may occur during, for example, exposure to actinic radiation.

In embodiments, the radiation curable phase-change inks disclosed herein may be cured after each layer of the three-dimensional object is deposited. In other embodiments, the inks may be cured upon completion of deposition of all layers of the three-dimensional object reducing the curing steps required to build a mechanically stable object, and further reducing the need to cure each layer after each deposition.

Curing of the ink may be effected by exposure of the ink image to actinic radiation at any desired or effective wavelength. For example, the wavelength may be from about 200 to about 600 nanometers. Exposure to actinic radiation may be for any desired or effective period of time. For example, the exposure may occur for about 0.2 to about 30 seconds, such as from about 1 to about 15 seconds.

In embodiments, an x, y, z movable substrate, stage, or build platform is employed to create a free-standing object. That is, there is no final substrate since the three-dimensional product is the free-standing, printed or fabricated object and not an image on a substrate. The removable build platform or support material may be any suitable material, for example, in embodiments, a non-curable material. Specific examples of suitable non-curable support materials include waxes, plastics, metals, wood, and glass, among others.

In embodiments, the three-dimensional object may have both rigid and rubbery components. For example, one component may be printed by using material comprising a curable monomer that imparts a lower or higher room temperature modulus than a curable monomer of another component of the object. In embodiments, the three-dimensional object may have alternating rigid and flexible layers within a single object, such as a rubber-like post with a hard cap on the end. In such an example, a low modulus material may initially be printed, followed by a subsequent later of high modulus material, and the printed material may subsequently be cured.

### EXAMPLES

Three colorless UV curable compositions A-C were formulated by mixing the listed components together at 90° C. (Table 1). In Table 1, Compound (I) (a curable amide gellant as described in Example VIII of U.S. Pat. No. 7,279,587 which is incorporated by reference herein, in its entirity), Compounds (II) (Dow UVR-6110) and (III) (commercially available as VEctomer® 4060 and VEctomer® 4230 from Morflex Inc., Greensboro, N.C.) are cationically curable monomers, and Compound (IV) (propoxylated neopentyl glycol diacrylate, obtained from Sartomer Co. Inc., Exton, Pa.) is a radically curable monomer.

TABLE 1
Preparation of compositions A-C where the compounds (I)-(VI) are shown below.

| | | | Formulation, wt % | | |
|---|---|---|---|---|---|
| Component | Structure | Function | A | B | C |
| Amide gellant | Compound (I) | Phase | 10 | 10 | 10 |
| | | change | | | |
| | | agent | | | |
| 3,4-epoxycyclohexylmethyl-3,4- | Compound (II) | Monomer | 80 | | |
| epoxycycloxanecarboxylate | | | | | |
| Bis[4-(vinyloxy)butyl] adipate | Compound (III) | Monomer | | 80 | 42.5 |
| SR9003 | Compound (IV) | Monomer | | | 42.5 |
| Chivacure 9000 | Compound (V) | Photo- | 10 | 10 | 2.5 |
| | | initiator | | | |
| Irgacure 127 | Compound (VI) | Photo- | | | 2.5 |
| | | initiator | | | |

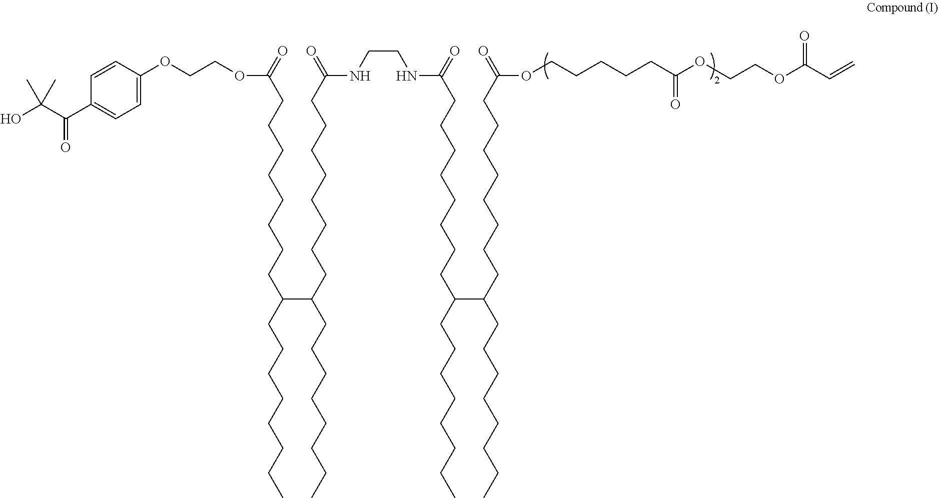

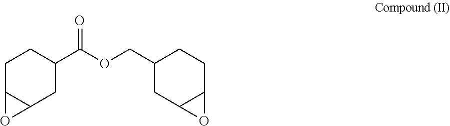

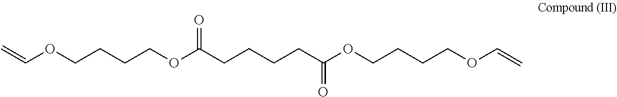

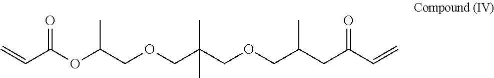

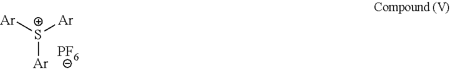

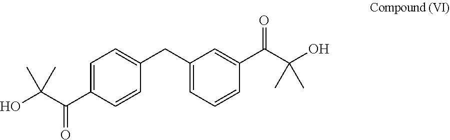

All of the above materials were fully miscible, giving clear solutions at elevated temperatures and forming stiff gels on cooling to room temperature, proving that the amide gellant can form gels with different types of monomers. Most importantly, each of the formulations were observed to cure, i.e., form polymers, when exposed to UV light (Lighthammer6, D bulb, 32 fpm). It is shown that any of these formulations would be suitable candidates for cationically or hybrid curable materials for 3D printing or digital fabrication.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for fabricating a three-dimensional object comprising:
depositing a composition comprising a cationically curable compound, a cationic photoinitiator, a radically curable compound, a radical photoinitiator, and a gellant upon a surface to create a three-dimensional object; and
curing the composition.

2. The method of claim 1, further comprising successively depositing additional amounts of the composition to create a three-dimensional object.

3. The method of claim 1, wherein the method for fabricating the three-dimensional object further comprises digital fabrication.

4. The method of claim 1, wherein depositing comprises manual deposition of the composition.

5. The method of claim 1, wherein depositing comprises manual deposition of the composition into a mold.

6. The method of claim 1, wherein depositing comprises depositing onto a substrate, stage, or removable support.

7. The method of claim 1, wherein depositing comprises depositing onto an x, y, z movable build platform.

8. The method of claim 1, wherein depositing the composition comprises depositing with an ink jet printing apparatus.

9. The method of claim 1, wherein depositing the composition comprises depositing with a piezoelectric ink jet printing apparatus.

10. The method of claim 1, wherein the surface comprises a substrate selected from the group consisting of plain paper, bond paper, silica coated paper, glossy coated paper, transparency materials, fabrics, textile products, plastics, polymeric films, metal, metalized plastics, wood, wax, and salts.

11. The method of claim 1, wherein multiple layers of the composition are cured upon completion of deposition of the last of the multiple layers of the object.

12. The method of claim 1, further comprising depositing successive layers of the composition to form an object having a selected height and shape.

13. The method of claim 1, wherein the composition further comprises a colorant.

14. The method of claim 1, wherein the composition is substantially free of colorant.

15. The method of claim 1, wherein the cationically curable compound comprises at least one moiety selected from the group consisting of an epoxide, a vinyl ether and a styrenic group.

16. The method of claim 1, wherein the radically curable compound comprises an acrylate.

17. The method of claim 16, wherein the acrylate is selected from the group consisting of propoxylated neopentyl glycol diacrylate, hexanediol diacrylate, tripropylene glycol diacrylate, dipropylene glycol diacrylate, amine modified polyether acrylates, trimethylolpropane triacrylate, dipentaerythritol penta-/hexa-acrylate, ethoxylated pentaerythritol tetraacrylate, tridecyl acrylate, 2-phenoxyethyl acrylate, 4-t-butylcyclohexyl acrylate, and mixtures thereof.

18. The method of claim 1, wherein the composition further comprises a reactive wax.

19. The method of claim 1, wherein the gellant is a compound of the following formula (I) 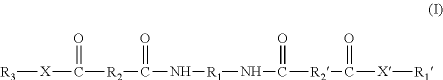
wherein R₁ is:
(i) an alkylene group having from about 1 to about 12 carbon atoms, wherein
the alkylene group is a divalent aliphatic group or alkyl group, and heteroatoms are optionally included in the alkylene group;
(ii) an arylene group having from about 1 to about 15 carbon atoms, wherein
the arylene group is a divalent aromatic group or aryl group, and heteroatoms are optionally present in the arylene group;
(iii) an arylalkylene group having from about 6 to about 32 carbon atoms, wherein
the arylalkylene group is a divalent arylalkyl group, wherein the alkyl portion of the arylalkylene group is linear or branched, saturated or unsaturated, and cyclic or acyclic, and wherein heteroatoms are optionally present in either the aryl or the alkyl portion of the arylalkylene group; or
(iv) an alkylarylene group having from about 5 to about 32 carbon atoms, wherein
the alkylarylene group is a divalent alkylaryl group, wherein the alkyl portion of the alkylarylene group is linear or branched, saturated or unsaturated, and cyclic or acyclic, and wherein heteroatoms are optionally present in either the aryl or the alkyl portion of the alkylarylene group;
R₂ and R₂′ each, independently of the other, is:
(i) alkylene groups having from 1 to about 54 carbon atoms,
(ii) arylene groups having from about 5 to about 15 carbon atoms,
(iii) arylalkylene groups having from about 6 to about 32 carbon atoms, or
(iv) alkylarylene groups having from about 6 to about 32 carbon atoms;
R₃ and R₃′ each, independently of the other, is:
(a) a photoinitiating group derived from 1-(4-(2-hydroxyethoxy)phenyl)-2-hydroxy-2-methylpropan-1-one of the formula (II): 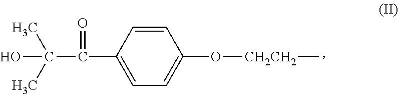
a group derived from 1-hydroxycyclohexylphenylketone of the formula (III): 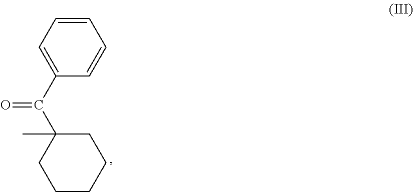
a group derived from 2-hydroxy-2-methyl-1-phenylpropan-1-one of the formula (IV): 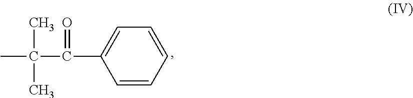
a group derived from N,N-dimethylethanolamine or N,N-dimethylethylenediamine, of the formula (V): 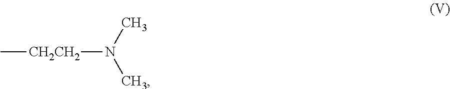
or the like; or
(b) a group which is:
(i) an alkyl group having from about 2 to about 100 carbon atoms, wherein the alkyl group is linear or branched, cyclic or acyclic, and substituted or unsubstituted, and wherein heteroatoms are optionally present in the alkyl group;
(ii) an aryl group having from about 5 to about 100 carbon atoms, wherein the aryl group is substituted or unsubstituted;
(iii) an arylalkyl group having from about 5 to about 100 carbon atoms; or
(iv) an alkylaryl group having from about 5 to about 100 carbon atoms; and
X and X′ each, independently of the other, is an oxygen atom or a group of the formula —NR₄—, wherein R₄ is:
(i) a hydrogen atom;
(ii) an alkyl group having from about 5 to about 100 carbon atoms,
(iii) an aryl group having from about 5 to about 100 carbon atoms,
(iv) an arylalkyl group having from about 5 to about 100 carbon atoms, or
(v) an alkylaryl group having from about 5 to about 100 carbon atoms.

20. A three dimensional object from about 1 to about 10,000 micrometers in height prepared by the method of claim 1, wherein multiple layers of the composition are cured upon completion of deposition of the last of the multiple layers and not all surfaces of each of the multiple layers received equal illumination.
